(19) United States
(12) Patent Application Publication
(10) Pub. No.: US 2005/0265190 A1
(43) Pub. Date: Dec. 1, 2005

(54) Recording apparatus

(75) Inventor: Toshimichi Kudo, Fujisawa-shi (JP)

Correspondence Address: Canon U.S.A Inc.;Intellectual Property Department, 15975 Alton Parkway, Irvine, CA, 92618-3731, US

(73) Assignee: Canon Kabushiki Kaisha, Ohta-ku (JP)

(21) Appl. No.: 11/135,084

(22) Filed: May 23, 2005

(30) Foreign Application Priority Data
May 27, 2004 (JP) 2004-157778

(51) Int. Cl. G11B 7/00

(52) U.S. Cl. 369/53.2; 369/53.24; 369/53.31; 369/53.41

(57) ABSTRACT

A recording apparatus according to the present invention includes an input unit for inputting information data, a recording unit for recording the inputted information data on a recording medium, a record remaining capacity detecting unit for detecting that the remaining capacity for recording on the recording medium is equal to or less than a predetermined quantity, and a deleting unit for selecting information data obtained from an information source other than a predetermined information source among the information data recorded on the recording medium according to an output from the record remaining capacity detecting unit, and for deleting the selected information data from the recording medium.

### BACKGROUND OF THE INVENTION

1. Field of the Invention

The present invention relates to a recording apparatus and more particularly to the deleting processing of recorded information data.

2. Description of the Related Art

Recently disk recorders which record and reproduce a video signal as digital data on an optical disk such as a rewritable digital versatile disk (DVD) and on a hard disk are appearing in the world.

In comparison with a VTR using a conventional magnetic tape as a recording medium, the disk recorder has many merits such as content management or reproduction which utilizes its random access performance, long time recording, and simultaneous reproducing of data which have been already recorded while recording is carried out.

On the other hand, in the field of a video camera, a DV system which records video data digitally on a small-sized cassette tape has been mainstream. However, also in this field, a product using a recording medium such as a rewritable DVD medium and a small-sized memory card which can be randomly accessed has been recently appearing.

With respect to such a disk recorder, a technique is known which uses its random access performance for securing a remaining capacity by automatically deleting already-played-back data when a recordable remaining capacity becomes little (see, for example, Japanese Patent Application No. 2002-112150 (corresponding U.S. Patent Application Publication No. U.S. 2002/0037154 A1)).

It is very convenient for users if they can utilize the function of deleting already-recorded data automatically, saving the inconvenience of specifying the data which should be deleted when the remaining capacity becomes little.

Disk media is widely spread as described above, and there is a case where both a household disk recorder and a video camera use the same disk and, the data of a television broadcast and the photograph data obtained by a user with a video camera are both included as the contents of the recorded data in the disk. The moving images photographed with the video camera are likely to be images of a travel, a family or some personal records. Consequently, trouble may occur that the moving images photographed with the video camera are deleted like a TV program just because they have been viewed and heard once.

However, according to the technique of the above-mentioned patent document, the already-played-back data is automatically deleted. Thus, this technique has a problem that even the contents photographed with a video camera are automatically deleted.

### SUMMARY OF THE INVENTION

The present invention is directed to overcome the above-described drawback and to prevent the deletion of the data from a specific information source even when the remaining capacity of a medium becomes little.

One aspect of the present invention is to provide a recording apparatus which includes an input unit configured to input information data, a recording unit configured to record the information data input by the input unit on a recording medium, a record remaining capacity detecting unit configured to detect that a remaining capacity for recording on the recording medium is equal to or less than a predetermined quantity, and a deleting unit configured to select information data obtained from an information source other than a predetermined information source among information data recorded on the recording medium according to an output of the record remaining capacity detecting unit, and delete the selected information data from the recording medium.

Other features and advantages of the present invention will become apparent to those skilled in the art upon reading of the following detailed description of embodiments thereof when taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a configuration of a video camera according to an embodiment of the present invention;

FIG. 2 shows a diagram illustrating a part of a flags attribute;

FIG. 3 shows an example of the state of moving image data, sound data, still image data and a play list stored on a recording medium;

FIG. 4 shows an element configuration of an XML document constituting a management file;

FIG. 5 shows a description example of the management information of a moving image directory “MOV00100” shown in FIG. 3; and

FIG. 6 is a flowchart illustrating an operation for securing a record remaining capacity at the time of recording in the embodiment of the present invention.

### DETAILED DESCRIPTION OF THE EMBODIMENTS

Embodiments of the invention will be described in detail below with reference to the drawings.

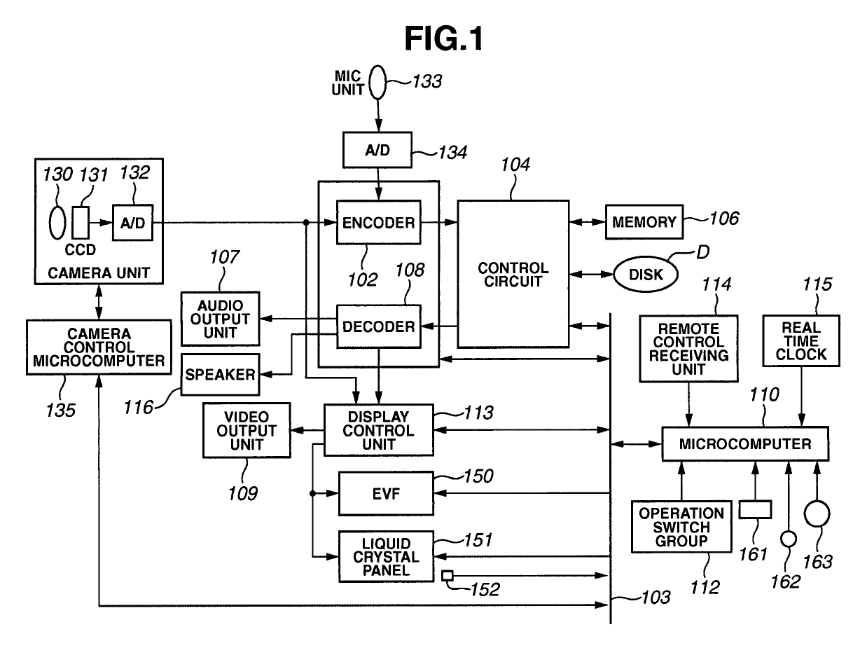

FIG. 1 shows the internal configuration of a video camera 100 to which the present invention is directed. The video camera 100 of the present embodiment uses a disk medium, such as a DVD, for recording.

In FIG. 1, reference numeral 130 denotes a lens unit. The lens unit 130 is composed of a fixed lens group for beam condensing, a variable power lens group, an iris, and a correcting lens group which has both the function of correcting an image forming position that shifts along with the movement of the variable power lens group and the function of focusing. A subject image is formed in the end by the lens unit 130 on the imaging surface of a charge coupled device (CCD) 131, which converts light into electrical charges in order to generate a picture signal. Reference numeral 132 denotes an A/D processing unit, which processes an imaging signal in a predetermined way to output digital image data. The lens unit 130, the CCD 131 and the A/D processing unit 132 constitute a camera unit. Moreover, the camera unit is equipped with actuators for the variable power lens group, the iris and the like, a sensor of unintentional movement of hands (for example, an angular velocity sensor), and correction unit for correcting the unintentional movement of hands (shift lens or the like), though they are not shown in FIG. 1.

Reference numeral 135 denotes a camera control microcomputer which controls the camera unit according to the control of a microcomputer 110, which is described below. The camera control microcomputer 135 transmits the information obtained from the camera unit such as information of focusing and unintentional movement of hands to the microcomputer 110.

Reference numeral 133 denotes a microphone unit for collecting sounds at the time of photographing, which performs predetermined amplifying and band limiting of the inputted sound signal. Reference numeral 134 denotes an A/D processing unit which receives the output of the microphone unit 133 and outputs digital sound data.

The microcomputer 110 includes a non-volatile memory (ROM) for storing programs, a volatile memory (RAM) for a work area, external buses for delivering and receiving data with other hardware and for accessing control registers, and a timer for measuring time. Reference numeral 103 denotes a bus. Each block is connected to the bus 103, which is a transmission path through which the data is delivered and received in conformity with the control by the microcomputer 110.

Reference numeral 102 denotes an encoder unit, which receives digital image data and digital sound data in conformity with the control by the microcomputer 110, compresses the information of the received data by coding with the Moving Picture Experts Group (MPEG) 2 system, and further multiplexes the compressed data in a chronological order to generate compressed video data. The encoder unit 102 also has a function of compressing and coding still image signals with the Joint Photographic Experts Group (JPEG) system to output compressed still image data. Moreover, the encoder unit 102 has a function of notifying the microcomputer 110 of the information necessary for, e.g. the conversion of a data position and a frame position.

Reference numeral 104 denotes a control circuit. The control circuit 104 has interfaces with the encoder unit 102, a memory 106, which is described below, an optical disc D and a decoder unit 108, and controls the delivery and the receipt of data according to the control of the microcomputer 110. Reference numeral 106 denotes the memory, and each block of the memory 106 can be used for work.

The control circuit 104 includes interfaces with the microcomputer 110 connected to the bus 103, and with a memory 106. The control circuit 104 further includes an optical beam pickup for writing and reading data from the optical disc D, mechanisms such as a seek motor for moving the pickup in a radial direction of the disk D and a spindle motor for rotating and driving the disk D, and circuits for controlling them. The control circuit 104 accesses a specified sector on the optical disc D to write and read data in conformity with the control of the microcomputer 110. The control circuit 104 has the so-called direct memory access (DMA) function to transfer read-out or write-in data automatically by specifying the starting address, the data quantity of the memory 106, and the write starting sector of the optical disc D.

Reference numeral 108 denotes the decoder unit. The decoder unit 108 sequentially reads compressed video data and compressed still image data from the address of the memory 106 specified by the microcomputer 110, converts the read data into digital image signals of, for example, ITU-R BT. 656 (CCIR 656) as well as digital sound signals, and outputs the converted signals.

Reference numeral 107 denotes an audio output unit, and reference numeral 109 denotes a video output part. The video output unit 109 and the audio output unit 107 are the blocks for converting into analog signals the digital image signals and the digital sound signals, respectively, which have been converted by the decoder unit 108 and output the converted analog signals to the outside. The video output unit 109 and the audio output unit 107 are connected to a television receiver or the like. Reference numeral 116 denotes a speaker unit. The speaker unit 116 receives the digital sound signals and reproducing sounds.

Reference numeral 113 denotes a display control unit. The display control unit 113 multiplexes various setting menus, titles, and time as the information for on screen display (OSD) onto the image signals outputted from the decoder unit 108 or the camera unit. The display control unit 113 also generates various image signals outputted from the camera unit based on the instructions from the microcomputer 110. Moreover, the display control unit 113 is equipped with a function of capturing a digital image signal inputted from the decoder unit 108, reducing the captured signal, and superimposing the reduced signal at an arbitrary position.

Reference numeral 112 denotes an operation switch group, reference numeral 161 denotes a photographing mode selecting switch, reference numeral 162 denotes a trigger switch, and reference numeral 163 denotes a mode dial. The microcomputer 110 judges a signal inputted by a user's operation and executes a function corresponding to the operation.

Reference numeral 114 denotes a remote control signal receiving unit, which receives a signal from an infrared remote control (not shown), and transmits the received signal as a pulse to the microcomputer 110. The microcomputer 110 converts the transmitted pulse to data and recognizes the converted data as a control command. The infrared remote control is a user's input unit similar to the operation switch group 112. Reference numeral 115 denotes a real time clock. The real time clock 115 transmits calendar and time information to the microcomputer 110. An initial value and a count starting command are inputted by a user with the operation switch group 112, and the initial value and the count starting command are given through the microcomputer 110 in order to add time stump information or the like to recorded moving image data.

The microcomputer 110 is provided with installed software handling a predetermined file system, and reading and writing of data to the optical disc D are performed in conformity with the file system. A series of moving image data recorded from the start of recording to the end is managed as one moving image data file.

Next, the process at the time of recording is described.

When a power supply is switched on, the microcomputer 110 searches a recordable (empty) area in the optical disk D based on the file system. At this time, the microcomputer 110 calculates a recordable capacity, and calculates a recordable time based on the recordable capacity and a recording mode. Hereafter, the microcomputer 110 monitors the reduction of the recordable capacity during recording, and periodically updates the recordable time. The microcomputer 110 always detects the state of the operation switch group 112 in order to monitor the operation of a user. In the following, it is presumed that all operations by a user are transmitted to the microcomputer 110 through the operation switch group 112, except where specifically noted.

Next, when the user makes a request to start recording, the microcomputer 110 proceeds to control each block so that recording of an image and a sound should be started. First, the microcomputer 110 makes the encoder unit 102 start MPEG 2 encoding process, and the encoder unit 102 outputs compressed video data to the control circuit 104. The control circuit 104 specifies an address in the memory 106 to temporarily store the compressed video data into the memory 106. Each time the memory 106 stores a predetermined quantity of data, the control circuit 104 notifies the microcomputer 110 thereof by means of interruption or the like.

The microcomputer 110 receives the notification and notifies the control circuit 104 of the starting address of the memory 106 where the compressed video data should be accumulated next. Furthermore, the microcomputer 110 issues a command to the control circuit 104 so that the compressed video data accumulated in the memory 106 should be written in the optical disk D. At this time, the recording area of the optical disk D is a recordable (empty) area which was searched in conformity with the file system. A series of processes from encoding to writing on an optical disc 120 is repeated until a request is made to stop recording.

The recorded compressed video data is entered as a moving image data file (extension “mpg”), which is described below. The management information about contents is described in a management file (extension “4C”), which is described below. A time map table file (extension “tbl”) is generated, and the information which is needed for special reproduction, handling a play list, editing and the like is described in the generated time map table file.

Next, a reproduction operation is described.

A moving image to be reproduced is selected by a user with the operation switch group 112. A reproduction image list or a representative image (thumbnail) connected to each image file is displayed (hereinafter referred to as a selection screen). A pointer is moved to a thumbnail image to determine a desired image, and a reproduction is started. In addition, a moving image at the head, a sequel to the one reproduced latest, a moving image recorded latest or the like may be reproduced otherwise by depressing a reproduction key (or a key allotted to issuing a reproduction command).

The microcomputer 110 instructs the control circuit 104 to read the data of the moving image file selected from the optical disc D as above described. In other words, the microcomputer 110 issues a command to the control circuit unit 104 to read data from the optical disk D and store the read data into the memory 106. At this time, the microcomputer 110 specifies a read-out starting sector of the optical disk D, a write-in starting address of the memory 106, and a quantity of data.

Next, the microcomputer 110 issues a command to the decoder unit 108 to decode the compressed video data stored in the memory 106. A series of the processes is repeatedly executed until processing the stored moving image data is completed, or until an instruction of a stop, a temporal stop or the like is issued.

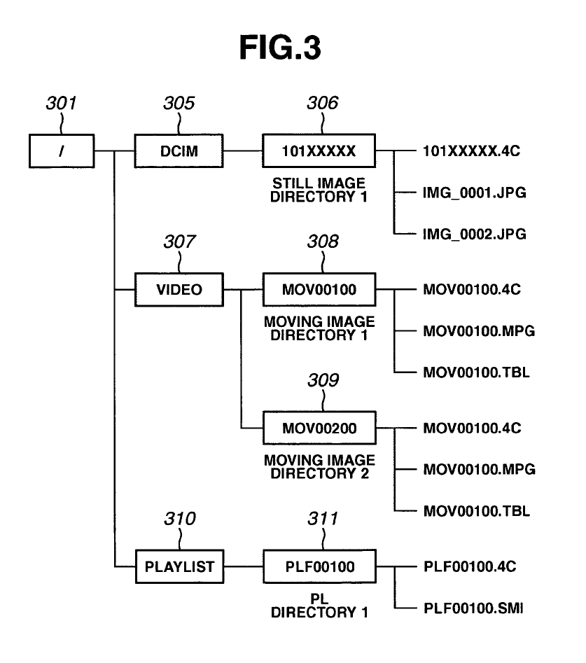

An example of the state in which moving image data, sound data, still image data, and a play list are stored in a recording medium is shown in FIG. 3. Reference numeral 301 denotes a directory at the uppermost layer of the layers in which the file groups generated by the present system are stored. The directory 301 is defined here as the root directory. The files having extensions “.4C” are management files, which are described below, and the files having extensions “.TBL” are time map table files, which are also described below.

Reference numeral 305 denotes a DCIM directory. In the DCIM directory 305, still image data is stored in accordance with the rules defined by the DCF standards. Reference numeral 307 denotes a VIDEO directory, in which moving image data is stored. The moving image data is a file having an extension “.MPG”. Reference numeral 310 denotes a PL directory, in which play lists are stored. That is, play list files (extension “.SMI”) are stored there. Actually, as shown in FIG. 3, subdirectories are created under each of these directories, and each file is created in each subdirectory.

In addition, a storage directory of each data is successively created by increasing the numeral portion of the name of each subdirectory, which is a number of four figures in the present embodiment. In FIG. 3, two image directories 308 and 309 are shown only in the moving image directory, but the still image directory 306 and the PL directory 311 can be created similarly.

The management file (the above-mentioned file having the extension “.4C”) is stored in each of the PL directory, the moving image directory and the still image directory and manages files stored in each directory. The details of the management file are described below.

The DCIM directory from 305 onward complies with another standard called as a DCF standard, and the directories must be arranged below the root directory. Accordingly, the other directories may be collected under another directory.

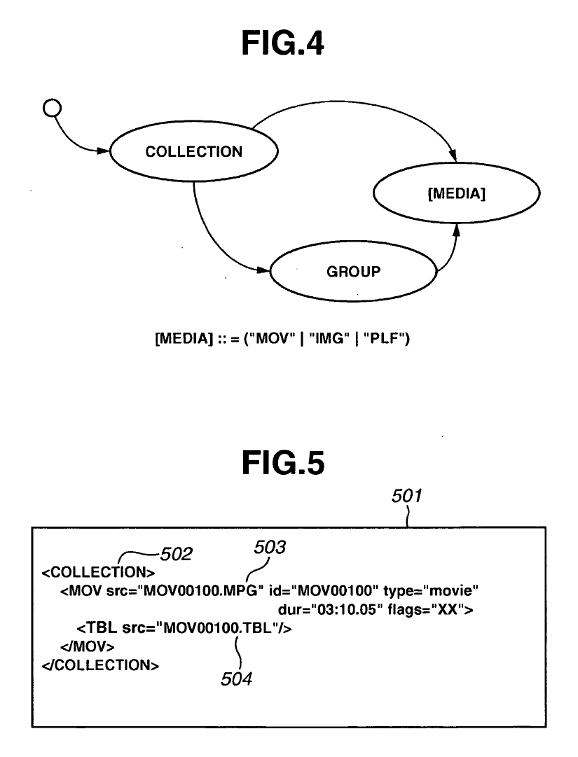

The management file is a text file described by the XML format. The element configuration of the XML documents constituting the management file is shown in FIG. 4.

A COLLECTION element is the route element of management information.

A GROUP element is used to group media objects such as a moving image and a still image. The GROUP element has an id attribute. An IMG element is used to describe the entry of still image data. An IMG element has an src attribute, an id attribute, a type attribute, a linkCount attribute, and a deleted attribute. The src attribute is used to describe a file name, and the id attribute is used to describe the identification name of a file. The identification name specified by the id attribute is unique in the management file. The type attribute expresses the kind of a file. In the case of a still picture, the type attribute takes on the “image” value. The attribute value of the linkCount attribute is an integer value, and shows the number of references with which each entry is referred to from the play list. The deleted attribute is deletion information and attribute values are “true” or “false.” When the linkCount attribute value is not 0 and a file is deleted, the deleted attribute value is set to “true.”

A MOV element is used to describe the entry of moving image data. Like an IMG element, the MOV element has the src attribute, the id attribute, the type attribute, the linkCount attribute, the deleted attribute, and a dur attribute. In the case of a moving image, a type attribute value is “movie.” The dur attribute describes the reproduction time of the whole moving image data, and takes on a clock value. The clock value (Clock-value) is expressed by the following form.

Clock-value::=(Full-Clock-value|Partial-Clock-value|Timecount-value)
Full-Clock-value::=Hours“:”Minutes“:”Seconds(“.”Fraction)?
Partial-Clock-value::=Minutes“:”Seconds(“.”Fraction)?
Timecount-value::=Timecount(“.”Fraction)?(Metric)?
Hours::=DIGIT+; any positive number
Minutess::=2DIGIT; range from 00 to 59
Seconds::=2DIGIT; range from 00 to 59
Fraction::=DIGIT+
Timecount::=DIGIT+
2DIGIT::=DIGIT DIGIT
DIGIT::=[0-9]

For example, in the case of 14 minutes and 3 seconds, the clock value is described as “00:14:03” or “14:03.”

The PLF element is used to describe the entry of the play list file (PLF), which is described below. A PLF element has the src attribute, the id attribute, the type attribute, the linkCount attribute, the deleted attribute and the dur attribute like the MOV element. Since there is the possibility that the PLF itself may be referred to from other play lists, the linkCount attribute and the deleted attribute are prepared also for the PLF element. In case of the PLF, the type attribute value is “playlist.”

The extension attached to the file name of the management file is set to “.4C.”

Next, a description example of the management information of the moving image directory “MOV00100” in FIG. 3 is shown in FIG. 5.

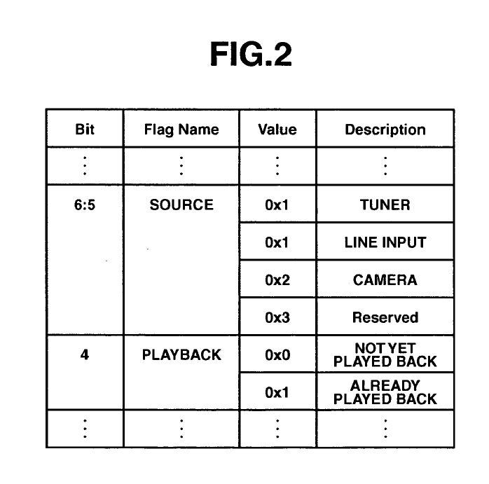

One MOV element 503 exists in a COLLECTION element 502, and each attribute is as described above. However, the flags attribute has at least the information as shown in FIG. 2. FIG. 2 shows a part of the flags attribute. As shown in FIG. 2, two bits of bit 5 and bit 6 are allotted to source information.

The source information shows a source when the contents corresponding to the management information were recorded. In FIG. 2, the source information is composed of 2 bits, and therefore the values of the source information can take from 0 to 3. The values of the source information are recorded at the time of recording, as follows, for example. When the source is a tuner, the source information is 0. When the source is a line input, the source information is 1. When the source is a camera, the source information is 2. Furthermore, a bit 4 is already-played-back information. The already-played-back information is the information for determining whether the data of the file has been already played back or not. 0 is entered at the time of recording, and is rewritten as 1 once the disk is reproduced.

The MOV element has a TBL element 504. The src attribute of the TBL element 504 is “MOV00100.TBL”, which indicates a time map table to be referred to. In addition, a related file may be described here. For example, in case of creating another file by after-recording, an element which indicates a sound file may be also described at this position.

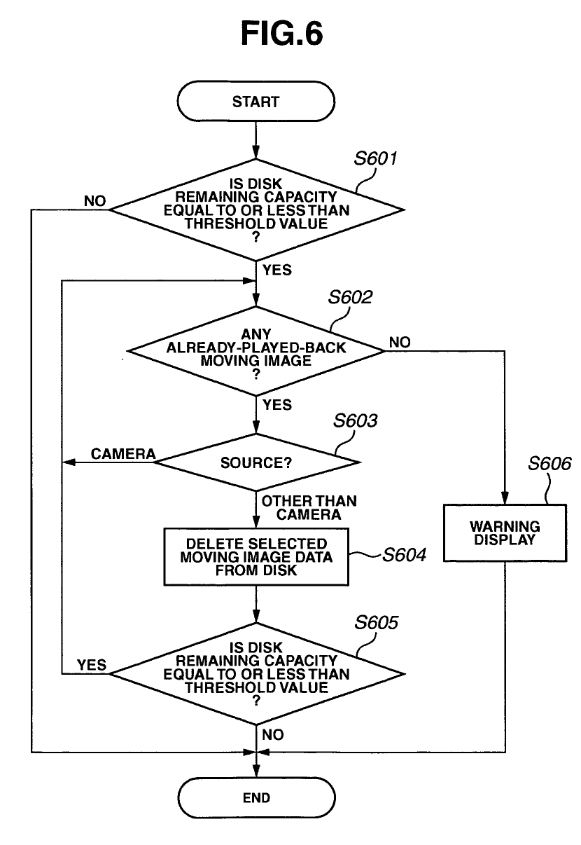

Next, the operation for securing a record remaining capacity at the time of recording is described with reference to the flowchart of FIG. 6.

For example, in case of the camera mode mentioned above, while photographing (recording) is being carried out by user operations, the microcomputer 110 processes the flow shown in FIG. 6 periodically at a predetermined intervals.

First, the file system which is installed software calculates a recordable remaining capacity in the disk D, and determines whether the calculated recordable remaining capacity is equal to a previously set threshold value (Step S601). When the recordable remaining capacity is not equal to or less than the threshold value, namely when the remaining capacity can afford recording, the microcomputer 110 ends the processing.

On the other hand, when the recordable remaining capacity is equal to or less than the threshold value, the microcomputer 110 refers to the flags attribute of the moving image data entry described in the management file to detect the already-played-back moving image data in the data recorded in the disk D based on the already-played-back information described in FIG. 2 (Step S602). In other words, when an entry exists and the bit 4 of its flags attribute is 1, the microcomputer 110 determines that the moving image data is the already-played-back moving image data. As a next step, the microcomputer 110 determines the source of the moving image data which has been determined to be the already-played-back moving image data (Step S603). In other words, the microcomputer 110 checks on the source information of the bits 5 and 6 of the flags attribute. When the microcomputer 110 determines that the source is a camera, the microcomputer 110 determines that the moving image data should not be deleted even though the moving image data has been already played back, and the process of the microcomputer 110 returns to Step S602.

when the source is something other than the camera, the microcomputer 110 deletes the moving image data from the disk D (Step S604). More specifically, the microcomputer 110 deletes the MPEG files described in the moving image data entry and the TBL files related to the MPEG files, and also deletes the moving image data entry from the management file.

As described above, when the microcomputer 110 searches the moving image data which has been already played back and the found data is the one other than the data photographed with the camera at Steps S602 and S603, the moving image data which satisfies the above condition is deleted from the disk D. Then, the microcomputer 110 determines whether the remaining capacity of the disk is greater than the threshold value as a result of the deletion (Step S605). When the record remaining capacity exceeds the threshold value, the microcomputer 110 ends the processing. However, when the remaining capacity of the disk is still equal to the threshold value or less even after the deletion of the moving image data, the processing of the microcomputer 110 returns to Step S602, and the microcomputer 110 repeats the search of the moving image data which should be a candidate for the next deletion and the deleting process is repeated.
when no moving image data other than that photographed with the camera can be detected after processing all moving image data currently recorded on the disk D in Steps S602 and S603, the microcomputer 110 displays a warning to the user that it is impossible to increase the remaining capacity because the contents as a delete candidate do not exist (Step S606).

Through the series of the processes, it is possible to prevent the moving image data photographed with a camera from being automatically deleted when the disk remaining capacity becomes insufficient during recording.

In addition, the automatic deleting as mentioned above may be made to function only at the time of camera photographing, and not to function at the time of an external input.

Moreover, although the management file has been described to be in XML form, its description form is not limited to that form, and any form that would enable practice of the present invention is applicable.

Moreover, although the management file has been described to be stored in each directory, the description form may be changed so that directory names and file names can be distinguished. In such a way the management files can be collected into one file.

Moreover, a user may make the automatic deletion function effective or ineffective with a menu which is generally installed to set or limit the functions of equipment.

Moreover, the flow of FIG. 6 is repeatedly executed while moving image data is being recorded on a disk in the above-mentioned embodiment. However, otherwise, when a new disk D is inserted, the flow of FIG. 6 can be executed. In this way it is determined whether the remaining capacity of the disk D has become little or not before starting a record. If the remaining capacity has become little, the data other than the moving images photographed with a camera is deleted from the disk D. Thereby, recording of a moving image can be started on the disk D in the state in which the record remaining capacity is secured.

The flow of FIG. 6 determines whether the disk remaining capacity exceeds the threshold value each time a moving image data file is deleted. However, instead of such a method, all moving image data files which have been already played back and the source of which is not the camera, recorded on the disk D may be detected. In this way a plurality of moving image data files is selected and deleted from the detected moving image data files collectively so that the disk remaining capacity may exceed the threshold value. In this case, the information on the data quantity of each moving image data file is described in the above-mentioned management file, and the disk remaining capacity which increases when each moving image data file is deleted can be detected based on the information on the data quantity.

While the video camera is described herein as the embodiment, the invention can be applied to a video recorder with a tuner or a recording reservation function in which an optical disc or the like is adopted as a recording medium. If a video recorder has an automatic deleting function similar to that of the present embodiment, the moving image data photographed with the camera can be protected when an optical disk containing the contents photographed with the video camera of the present embodiment is inserted into a disk recorder and the recording is done on the disk.

When such a type of the video recorder has an external input output interface (I/F) like the USB, the moving image data, which has been transferred through the external input output I/F, can be recorded. Also in this case, if the transferred moving image data is the moving image data photographed with the camera, the source information in the management information may be described as a camera.

Moreover, the recording medium may be a card type memory in which a non-volatile semiconductor memory is embedded.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-157778 filed May 27, 2004, which is hereby incorporated by reference herein.

1. A recording apparatus, comprising:
an input unit configured to input information data;
a recording unit configured to record the information data input by the input unit on a recording medium;
a record remaining capacity detecting unit configured to detect that a remaining capacity for recording on the recording medium is equal to or less than a predetermined quantity; and
a deleting unit configured to select information data obtained from an information source other than a predetermined information source among information data recorded on the recording medium according to an output of the record remaining capacity detecting unit, and delete the selected information data from the recording medium.

2. A recording apparatus according to claim 1, wherein the deleting unit further detects already-played-back information data among the information data recorded on the recording medium, and selects information data obtained from the information source other than the predetermined information source among the already-played-back information data to delete the selected information data from the recording medium.

3. A recording apparatus according to claim 1, further comprising a reproducing unit configured to reproduce management information on the recording medium which indicates an information source of information data recorded on the recording medium, wherein the deleting unit detects the information source of the information data recorded on the recording medium based on the management information reproduced by the reproducing unit.

4. A recording apparatus according to claim 1, wherein the information data is moving image data, the information source includes a video camera, and the deleting unit selects the moving image data other than the moving image data transferred from the information source of the video camera to delete the selected moving image data from the recording medium.

5. A recording apparatus according to claim 4, wherein the information source further includes a tuner for receiving a television broadcast and a line input.

6. A recording apparatus according to claim 1, wherein the recording unit further records management information indicating the information source of the inputted information data on the recording medium.

7. A recording apparatus according to claim 1, wherein the deleting unit detects the information source of the information data recorded on the recording medium based on management information indicating the information source of the information data recorded on the recording medium.

8. A recording apparatus according to claim 1, wherein the deleting unit executes deleting processing in response to a detection output of the record remaining capacity detecting unit during recording the information data to the recording medium.

9. A recording apparatus according to claim 1, wherein the deleting unit executes deleting process in response to a detection output of the record remaining capacity detecting unit in a period except when the information data is being recorded.

10. A recording apparatus according to claim 1, wherein the deleting unit selects the information data to be deleted so that the record remaining capacity of the recording medium exceeds the predetermined quantity.

11. An apparatus including an automatic deleting function for securing a remaining capacity of a recording medium by automatically deleting already-played-back video data among video data recorded in the recording medium when the remaining capacity of the recording medium is equal to or less than a predetermined quantity during recording video data on the recording medium, wherein
the apparatus excludes the video data photographed with a video camera and recorded on the recording medium among the already-played-back video data from candidates for automatic deletion.

12. A method for deleting selected information data from a recording medium, the method comprising:
inputting information data;
recording the information data input by the input step on a recording medium;
detecting that a remaining capacity for recording on the recording medium is equal to or less than a predetermined quantity;
selecting information data obtained from an information source other than a predetermined information source among information data recorded on the recording medium according to an output of the record remaining capacity detecting step; and
deleting the selected information data from the recording medium.

13. The method according to claim 12, further comprising detecting already-played back information data among the information data recorded on the recording medium, and selecting information data obtained from the information source other than the predetermined information source among the already-played back information data to delete the selected information data from the recording medium.

14. A method according to claim 12, further comprising reproducing management information on the recording medium which indicates an information source of information data recorded on the recording medium, wherein detection of the information source of the information data recorded on the recording medium is based on the reproduced management information.

15. A method according to claim 12, wherein the information data is moving image data, the information source includes a video camera, and selecting the moving image data other than the moving image data transferred from the information source of the video camera to delete the selected moving image data from the recording medium.

16. A method according to claim 15, wherein the information source further includes a tuner for receiving a television broadcast and a line input.

17. A method according to claim 12, wherein detecting the information source of the information recorded on the recording medium is based on management information indicating the information source of the information data recorded on the recording medium.

18. A method according to claim 12, wherein deletion of the selected information data is executed in response to detecting the remaining capacity for recording during recording the information data to the recording medium.

19. A method according to claim 12, wherein deletion of the selected information data is executed in response to detecting the remaining capacity for recording in a period except when the information data is being recorded.

20. A method according to claim 12, wherein selection of the information data to be deleted is such that the record remaining capacity of the recording medium exceeds the predetermined quantity.

21. Computer-executable process steps for causing a computer to execute the method of claim 12.
